(19) United States
(12) Patent Application Publication
(10) Pub. No.: US 2024/0390720 A1
(43) Pub. Date: Nov. 28, 2024

(54) FIRE SUPPRESSION COMPOSITION COMPRISING INERT GAS BLEND

(71) Applicant: KIDDE GRAVINER LIMITED, Shirley (GB)

(72) Inventors: Adam Chattaway, Old Windsor (GB); Terry Simpson, Wake Forest, NC (US)

(21) Appl. No.: 18/650,044

(22) Filed: Apr. 29, 2024

(30) Foreign Application Priority Data
May 26, 2023 (EP) 23275085.1

(51) Int. Cl. A62D 1/00; A62C 3/08; A62C 99/00

(52) U.S. Cl. CPC A62D 1/0092; A62C 99/0018; A62C 3/08

(57) ABSTRACT

A fire suppression composition for use in an enclosed space, such as a cargo hold of an aircraft, as well as a fire suppression system or device, a method of suppressing a fire, and a method for preparing a fire suppression composition, are disclosed. The fire suppression composition includes: component (1), being 50 to 95 mol % nitrogen, based on the total fire suppression composition; component (2), being 5 to 25 mol % carbon dioxide or argon or a mixture thereof based on the total fire suppression composition; and component (3), being 0 to 25 mol % helium or neon or a mixture thereof, based on the total fire suppression composition; wherein the fire suppression composition has a density in the range of 1.1 to 1.3 kg/m³ at atmospheric pressure and 20° C.

### CROSS-REFERENCE TO RELATED APPLICATION(S)

This application claims the benefit of European Application No. 23275085.1, filed May 26, 2023 for “FIRE SUPPRESSION COMPOSITION COMPRISING INERT GAS BLEND” by T. Simpson, A. Chattaway, which is incorporated herein by reference in its entirety.

### TECHNICAL FIELD

The present disclosure relates to a fire suppression composition, as well as a fire suppression system or device, a method of suppressing a fire, and a method for preparing the fire suppression composition.

### BACKGROUND

Enclosed area fire suppression systems, such as those commonly used in aircraft, but which may also be used elsewhere, are known. Halon 1301 (bromotrifluoromethane, CF₃Br) has frequently been employed as a fire suppression agent. However, production of this agent was banned in 1994 due to its high ozone depleting potential. There is, therefore, a longstanding desire to replace Halon 1301 with more environmentally friendly fire suppression agents.

A number of replacements for Halon 1301 have been suggested including hydrofluorocarbons (HFCs), 2-bromo-trifluoropropene (2-BTP), and various combinations of inert gas and water mist. However, HFC's and 2-BTP fail a key aviation Minimum Performance Standard test and recent proposed environmental regulation would prohibit their use. More environmentally friendly alternatives such as nitrogen and water mist, are relatively inefficient fire extinguishing agents and the resulting size and weight of the fire protection system needed has been deemed unacceptable. Accordingly, a solution is needed that would provide better fire suppression compositions.

### SUMMARY

According to a first aspect, this disclosure relates to a fire suppression composition including: component (1), being 50 to 95 mol % nitrogen, based on the total fire suppression composition; component (2), being 5 to 25 mol % carbon dioxide or argon or a mixture thereof based on the total fire suppression composition; and component (3), being 0 to 25 mol % helium or neon or a mixture thereof, based on the total fire suppression composition; wherein the fire suppression composition has a density in the range of 1.1 to 1.3 kg/m³ at atmospheric pressure and 20° C.

The density of the fire suppression composition can be in the range of 1.15 to 1.25 kg/m³, or about 1.2 kg/m³ at atmospheric pressure and 20° C.

Component (2), which is denser than nitrogen, and can be called the “heavier agent” may be 75 to 100% carbon dioxide; 85 to 100% carbon dioxide; 95 to 100% carbon dioxide; or 100% carbon dioxide with the remainder, if any, being argon; while component (3), which is less dense than nitrogen, and can be called the “lighter agent”, may be 75 to 100% helium; 85 to 100% helium; 95 to 100% helium; or 100% helium, with the remainder, if any, being neon.

The fire suppression composition may consist essentially of or consist of nitrogen, carbon dioxide and optionally argon and/or helium and/or neon. “Consist essentially” of means that further components can be present which do not materially affect the essential characteristics of the fire suppression composition, and “consist of” means that no further component can be present. The composition may consist essentially of or consist of nitrogen, carbon dioxide and helium.

The fire suppression composition may include: component (1), being 50, 60, 70 or 75 to 80, 85, 90 or 95 mol % or 78 to 94 mol % nitrogen; component (2), being 5, 10, 12, or 14 to 15, 18, 20 or 25 mol % carbon dioxide or argon or a mixture thereof; and component (3), being 0, 2, 5 or 6 to 8, 10, 15, 20 or 25 mol % helium or neon or a mixture thereof, all based on the total fire suppression composition.

A preferred fire suppression composition includes: component (1), being 70 to 95 mol % nitrogen; component (2), being 5 to 20 mol % carbon dioxide or argon or a mixture thereof; and component (3), being 0 to 10 mol % helium or neon or a mixture thereof, all based on the total fire suppression composition. A particularly effective fire suppression composition includes: component (1), being 75 to 85 mol % nitrogen; component (2), being 12 to 18 mol % carbon dioxide; and component (3), being 4 to 8 mol % helium, all based on the total fire suppression composition.

According to a second aspect, this disclosure relates to a fire suppression system or device, which includes a fire suppression composition according to the first aspect. The device can be a fire extinguisher, fire suppression device, or storage device. The fire suppression system can include a fire suppression composition herein described and a dispensing component (such as one or more nozzles that dispense the fire suppression composition), as is in known in the art.

According to a third aspect, this disclosure relates to a method for suppressing a fire, the method including the steps of: detecting a fire; and dispensing a fire suppression composition according to the first aspect. Dispensing the fire suppressing composition can involve initiating one or more high rate discharge (HRD) stages followed by one or more low rate discharge (LRD) stages.

According to a fourth aspect, this disclosure relates to a method for preparing a fire suppression composition, said method including the step of combining: component (1), being 50 to 95 mol % nitrogen, based on the total fire suppression composition; component (2), being 5 to 25 mol % carbon dioxide or argon or a mixture thereof based on the total fire suppression composition; and component (3), being 0 to 25 mol % helium or neon or a mixture thereof, based on the total fire suppression composition; wherein the fire suppression composition has a density in the range of 1.1 to 1.3 kg/m³ at atmospheric pressure and 20° C.

### DETAILED DESCRIPTION

The disclosed approach eliminates the use of Halon 1301 and replaces it with an efficient yet environmentally friendly fire suppression agent, comprising nitrogen, carbon dioxide and/or argon, and optionally helium and/or neon. The compositions proposed are all more efficient than nitrogen alone, and have the additional benefit that they have the same or a similar density to air. They also have the advantage of reducing the weight and volume compared to traditional inert gas systems.

Component (2), the heavier agent, especially carbon dioxide, is a more effective fire suppressant than nitrogen alone and makes the blend more efficient, whereas component (3), the lighter agent, will reduce the density of the gas mixture. By carefully selecting the proportions of each component, it is possible to create a family of blends that all have the same or similar density as air, which is 1.20 kg/m³ at atmospheric pressure and 20° C. This advantageously means that the blend will not stratify post discharge.

Component (1), nitrogen (N2), is the major component of the fire suppression composition, and is present in an amount of 50 to 95 mol %, based on the total fire suppression composition. Nitrogen is an inert gas, and a well-known fire suppression agent. The fire suppression composition can comprise nitrogen in an amount of 60, 70 or 75 to 95 mol % or 78 to 94 mol %.

The mol % nitrogen, and all mole percentages given herein, unless otherwise stated, are based on the total fire suppression composition, i.e., the number of moles of one component (e.g., nitrogen), divided by the total number of moles of all components in the composition×100.

As is well known, the deviation from ideal gas law under atmospheric conditions (i.e., 1 atm, 101.325 kPa, or 14.7 psi, and at 20° C.), is negligible, so the volume percentage under these conditions would be essentially the same as the mole percentage. However, at different pressures or temperatures, for example when the fire suppression composition is stored in a cylinder at pressure of several hundred bar (several thousand psi), deviations from ideal gas law (compressibility) would need to be considered.

The fire suppressing composition also comprises component (2), a “heavier agent”, by which we mean of higher density than nitrogen under atmospheric conditions. The heavier agent is carbon dioxide and/or argon.

Carbon dioxide (CO₂) is a physically acting fire suppression agent, and is able to remove a large amount of heat from its surroundings (i.e., has a high heat capacity). This temperature reduction can reduce the severity of the fire. Carbon dioxide is a more effective suppressant than nitrogen and makes the blend more efficient.

Carbon dioxide is also more effective as a suppressant than argon, but it is toxic at concentrations above 9% of the atmosphere. For some types of aircraft, a typical concentration of inert gases for aircraft fire suppression systems in cargo bays is in the range of 40% to 50%, depending on the particular system. Accordingly, there is naturally an upper limit for its inclusion in the blend. Therefore, although less efficient as a suppressant, argon (Ar), which is also heavier than nitrogen, and works in a similar way, can be useful as an alternative to or more commonly in addition to, carbon dioxide. Carbon dioxide is more efficient than argon as a fire suppression agent, so generally makes up the majority or all of component (2).

The heavier agent, component (2), is present in an amount of 5 to 25 mol %, or 5 to 15 or 20 mol %, based on the total fire suppression composition and typically comprises 75 to 100% carbon dioxide; 85 to 100% carbon dioxide; 95 to 100% carbon dioxide; or 100% carbon dioxide, with the remainder being argon.

Nitrogen makes up the majority of air, about 78%, along with about 21% oxygen, about 0.93% argon, and trace amounts of many other gases. Oxygen is heavier (higher density under atmospheric conditions) than nitrogen, so a blend of nitrogen and carbon dioxide and/or argon (which are also heavier than nitrogen), can be made that has the same or a similar density as air by carefully selecting the relative amounts.

However, in most cases the blend of nitrogen and carbon dioxide and/or argon will be denser than air. In this case, component (3), a lighter agent, can be added to the composition. By lighter agent, by which we mean of lower density than nitrogen under atmospheric conditions. Component (3) comprises helium and/or neon gas, which will reduce the density of the composition. Helium and neon work in the same way, but helium is less expensive and lighter than neon, so generally makes up the majority or all of the lighter agent. Component (3) is present in an amount of 0 to 25, 20, 15 or 10 mol %, or 2 to 8% mol %, all based on the total fire suppression composition and may comprise 75 to 100% helium; 85 to 100% helium; 95 to 100% helium; or 100% helium, with the remainder being neon.

By carefully selecting the proportions of each component, it is possible to create a range of fire suppressing compositions that all have the same or a similar density to air, by which we mean a density in the range of 1.1 to 1.3 kg/m³ at atmospheric pressure and 20° C. The density of the fire suppression composition can be in the range of 1.15 to 1.25 kg/m³, or around 1.20 kg/m³ at atmospheric pressure and 20° C. Atmospheric pressure is taken as 1 atm (101.325 kPa, or 14.7 psi).

The result of this is that the composition will not stratify post discharge, which is beneficial in terms of maintaining a fire suppressing concentration in an enclosed space for longer periods of time. Most fire suppression agents are denser than air and stratify, i.e., sink to the lower regions of the space to be protected, leaving the upper area of the space unprotected.

Fire suppressing systems for an aircraft cargo compartment comprises two distinct phases: initial high rate discharge (HRD) to knock the fire down, followed by a subsequent low rate discharge (LRD) to keep the fire suppressed or contained until the aircraft can land safely. The HRD is a turbulent discharge, meaning the gases are well mixed, so stratification of the fire suppression composition is less of a problem than during the LRD where there is less forced mixing. Accordingly, the present composition is particularly beneficial during the LRD phase, when stratification of traditional fire suppression could lead to less effective fire suppression than with the present fire suppression composition.

The fire suppression composition may consist essentially of or consist of nitrogen, carbon dioxide and optionally argon and/or helium and/or neon; or just nitrogen, carbon dioxide and helium. In addition to these components, the fire suppression compositions disclosed herein can further comprise one or more additional components.

The additional components may be selected from a gas (e.g., an inert gas), an additional fire suppressant compound, odorants, or combinations thereof. Examples of fire suppression components include CF3I, HFCs, Novec™ 1230, HCFOs or 2-BTP. Examples of odorants include compounds which include one or more carbon-carbon double bonds, and/or compounds which are aromatic. The odorant compounds may further include a hydroxyl group, an iodine group, or both.

The total amount of additional components, if present, may be present in an amount of up to 25 mol %, or up to 20, 15, 10, 8, 5, 3, 2, 1, or 0.5 mol %, e.g., from 0.1 mol % up to these limits, based on the total moles of the fire suppression composition. The additional components, if present, may be one or more gases, e.g., an inert gas.

This disclosure also relates to a fire suppression system or device, as are known in the art, and a method for suppressing (or extinguishing) a fire, using the fire suppression composition disclosed herein.

The method of suppressing a fire may comprise a multi-stage fire suppression system including one or more HRD stages and one or more LRD stages. The fire suppression composition is particularly suitable for use in an enclosed space, such as a cargo hold of an aircraft and, as noted above, has particular advantages during an LRD stage.

This disclosure also relates to a method for preparing a fire suppression composition, which involves combining the components together in the relevant amounts. They are usually combined in the same container and stored under pressure, but can be stored in different containers, and combined at the point of use.

### EXAMPLES

The table below illustrates some of the possible blends, but it should be recognized that others are available.

TABLE 1
CBV of constituent gases individually, and 8 examples of blends that have
the same density as air. Percentages in the blends 1 to 8 are given by mol %.
Density is calculated at 1 atm pressure and 20° C.

| Option | CBV | 1 | 2 | 3 | 4 | 5 | 6 | 7 | 8 |
|---|---|---|---|---|---|---|---|---|---|
| Agent | | Amt | Amt | Amt | Amt | Amt | Amt | Amt | Amt |
| N2 | 30 | 94.05% | 87.30% | 88.97% | 90.63% | 92.30% | 78.97% | 86.57% | 66.52% |
| CO2 | 21 | 5.95% | 10.00% | 9.00% | 8.00% | 7.00% | 15.00% | 8.00% | 15.00% |
| He | 32 | 0.00% | 2.70% | 2.03% | 1.37% | 0.70% | 6.03% | 2.72% | 0.00% |
| Ar | 41 | 0.00% | 0.00% | 0.00% | 0.00% | 0.00% | 0.00% | 2.72% | 0.00% |
| Ne | 37 | 0.00% | 0.00% | 0.00% | 0.00% | 0.00% | 0.00% | 0.00% | 18.48% |
| CBV (Est.) | | 29.25% | 28.81% | 28.92% | 29.03% | 29.14% | 28.29% | 29.26% | 29.15% |
| Density | | 1.20 | 1.20 | 1.20 | 1.20 | 1.20 | 1.20 | 1.20 | 1.20 |
| (kg/m3) | | | | | | | | | |
| Percent | | 2.49% | 3.95% | 3.60% | 3.23% | 2.87% | 5.71% | 2.47% | 2.85% |
| Improvement | | | | | | | | | |
| over N2 | | | | | | | | | |

There are many methods of calculating density of mixtures of gases. For the sake of simplicity, the method used to generate the table above was to match the molecular mean weight of the gases in the blend to that of air. Data was taken from the Engineering Toolbox website.

CBV refers to cup burner values obtained in the cup burner test, a standard laboratory test for measuring extinguishing concentration. A cup burner is a relatively simple apparatus used to measure the extinguishing concentration of a fire extinguishing agent, or in this case, a blend of agents. The cup burner test is quick to perform, uses little extinguishing agent and gives repeatable results. It is regarded as an industry standard test for evaluating fire extinguishing agents.

In a cup burner test, a flame is established in a cup, situated in the centre of a glass tube. There is an airflow in the tube to feed the flame. Into this airflow the extinguishing agent is introduced, and its concentration is gradually increased until the flame is extinguished. The agent concentration is measured, giving the CBV, and the test is then repeated. The estimated values here are taken from the following reference: R S Sheinson. J E Penner-Hahn & D Indritz, “The Physical and Chemical Action of Fire Suppressants”, Fire Safety Journal 15 (1989), 437-450.

The results show that 28.81 to 29.26% of the fire suppression composition is needed as a mol percentage of the air to extinguish the flame. Accordingly, all 8 blends have a predicted extinguishing concentration lower than that of nitrogen, which is 30%. In particular, we can see that there is around a 2.5-5.7% improvement on using nitrogen only, in addition to the density advantage which can improve the performance further in a real-life fire situation, as explained above.

Compositions 1 to 7 are less efficient than carbon dioxide alone, but are safer, since carbon dioxide is toxic at its extinguishing concentration. Compositions 1 to 8 all have the same density as air, so would not stratify on dispersion, leading to better fire suppression in an enclosed space, especially during an LRD stage. Additionally, compositions 1 to 8 have the extra benefit that they are more efficient than nitrogen alone.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” or “includes” and/or “including”, when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A fire suppression composition comprising:
component (1), being 50 to 95 mol % nitrogen, based on the total fire suppression composition;
component (2), being 5 to 25 mol % carbon dioxide or argon or a mixture thereof based on the total fire suppression composition; and
component (3), being 0 to 25 mol % helium or neon or a mixture thereof, based on the total fire suppression composition;
wherein the fire suppression composition has a density in the range of 1.1 to 1.3 kg/m³ at atmospheric pressure and 20° C.

2. The fire suppression composition according to claim 1, which has a density in the range of 1.15 to 1.25 kg/m³ at atmospheric pressure and 20° C.

3. The fire suppression composition according to claim 1, wherein component (2) is 75 to 100% carbon dioxide, with the remainder being argon.

4. The fire suppression composition according to claim 1, wherein component (3) is present, and is 75 to 100% helium, with the remainder being neon.

5. The fire suppression composition according to claim 1, which consists essentially of nitrogen and carbon dioxide.

6. The fire suppression composition according to claim 5, which further consists of at least one of argon, helium, or neon.

7. The fire suppression composition according to claim 1, which consists essentially of nitrogen, carbon dioxide and helium.

8. The fire suppression composition according to claim 1, which comprises:
component (1), being 75 to 95 mol %, based on the total fire suppression composition;
component (2), being 5 to 15 mol % carbon dioxide or argon or a mixture thereof based on the total fire suppression composition; and
component (3), being 2 to 8 mol % helium or neon or a mixture thereof, based on the total fire suppression composition.

9. The fire suppression composition according to claim 1, which comprises:
component (1), being 78 to 94 mol % nitrogen, based on the total fire suppression composition;
component (2), being 5 to 15 mol % carbon dioxide or argon or a mixture thereof based on the total fire suppression composition; and
component (3), being 2 to 8 mol % helium or neon or a mixture thereof, based on the total fire suppression composition.

10. A fire suppression system or device comprising the fire suppression composition of claim 1.

11. A method for suppressing a fire, the method comprising the steps of:
detecting a fire; and
dispensing the fire suppression composition of claim 1.

12. The method according to claim 11, wherein dispensing the fire suppressing composition involves initiating one or more high rate discharge stages followed by one or more low rate discharge stages.

13. A method for preparing a fire suppression composition, said method comprising the step of combining: component (1), being 50 to 95 mol % nitrogen, based on the total fire suppression composition; component (2), being 5 to 25 mol % carbon dioxide or argon or a mixture thereof based on the total fire suppression composition; and component (3), being 0 to 25 mol % helium or neon or a mixture thereof, based on the total fire suppression composition; wherein the fire suppression composition has a density in the range of 1.1 to 1.3 kg/m³ at atmospheric pressure and 20° C.

14. The method according to claim 13, wherein the fire suppression composition has a density in the range of 1.15 to 1.25 kg/m³ at atmospheric pressure and 20° C.

15. The method according to claim 13, wherein component (2) is 75 to 100% carbon dioxide, with the remainder being argon.

16. The method according to claim 13, wherein component (3) is present, and is 75 to 100% helium, with the remainder being neon.

17. The method according to claim 13, wherein the fire suppression composition comprises:
component (1), being 75 to 95 mol % nitrogen, based on the total fire suppression composition;
component (2), being 5 to 15 mol % carbon dioxide or argon or a mixture thereof based on the total fire suppression composition; and
component (3), being 2 to 8 mol % helium or neon or a mixture thereof, based on the total fire suppression composition.

18. The method according to claim 13, wherein the fire suppression composition comprises:
component (1), being 78 to 94 mol % nitrogen, based on the total fire suppression composition;
component (2), being 5 to 15 mol % carbon dioxide or argon or a mixture thereof based on the total fire suppression composition; and
component (3), being 2 to 8 mol % helium or neon or a mixture thereof, based on the total fire suppression composition.
